(19) United States
(12) Patent Application Publication
(10) Pub. No.: US 2015/0356596 A1
(43) Pub. Date: Dec. 10, 2015

(54) SYSTEM FOR TRACKING EFFECTIVENESS OF ELECTRONIC PROMOTIONS

(71) Applicant: TOSHIBA TEC KABUSHIKI KAISHA, Tokyo (JP)

(72) Inventor: Kenya HIRAMATSU, Kita Tokyo (JP)

(21) Appl. No.: 14/734,575

(22) Filed: Jun. 9, 2015

(30) Foreign Application Priority Data
Jun. 10, 2014 (JP) 2014-119964

(51) Int. Cl. G06Q 30/02

(52) U.S. Cl. CPC G06Q 30/0243

(57) ABSTRACT

A system is for tracking effectiveness of electronic promotions distributed to a plurality of mobile computing devices over a network. A system includes a promotion distribution unit and a central management server. The promotion distribution unit is configured to distribute content of the promotions to mobile computing devices of users, each of the promotions having a promotion ID and a product ID associated therewith. The central management server is configured to store in a first table, the promotion IDs and the products IDs in association with each other, to store in a second table, a promotion ID, a user ID, and a promotion viewing time in association with each other, upon receiving confirmation from a mobile computing device, and to store electronic receipt data. The central management server is further configured to compute an effectiveness value for each of the promotions.

### CROSS-REFERENCE TO RELATED APPLICATION

This application is based upon and claims the benefit of priority from Japanese Patent Application No. 2014-119964, filed Jun. 10, 2014, the entire contents of which are incorporated herein by reference.

### FIELD

Embodiments described herein relate generally to a system for tracking effectiveness of electronic promotions.

### BACKGROUND

An electronic receipt system transmits electronic data of a purchase transaction at a store (i.e., an electronic receipt) to a computing device of a customer, such as a mobile device, instead of a conventional paper receipt that is handed to the customer upon completion of the purchase transaction. The electronic receipt is useful to the customer, because the customer can manage his or her purchase transactions electronically.

In the related art, sales promotions (such as advertisements) of a specific product or a specific store are distributed via various media such as the Internet media and mass communication media. After launching the sales promotions, retailers and manufacturers of products or marketing companies often analyze effectiveness of the sales promotions. It would be convenient to these business entities if the effectiveness of the sales promotions can be analyzed easily.

### DESCRIPTION OF THE DRAWINGS

FIG. 1 illustrates an overall configuration of an electronic receipt system according to an embodiment.

FIG. 2 is a block diagram of a POS terminal in the electronic receipt system.

FIG. 3 is a block diagram of an electronic receipt server in the electronic receipt system.

FIG. 4 is a block diagram of a management server in the electronic receipt system.

FIG. 5 illustrates a data configuration of a membership table stored in the management server.

FIG. 6 illustrates a data configuration of a purchase history table stored in the management server.

FIG. 7 illustrates a data configuration of a promotion setting table stored in the management server.

FIG. 8 illustrates a data configuration of a promotion history table stored in the management server.

FIG. 9 is a block diagram a promotion server configuration in the electronic receipt system.

FIG. 10 is a block diagram of an information provision server in the electronic receipt system.

FIG. 11 is a block diagram of a user terminal in the electronic receipt system.

FIG. 12 illustrates a functional configuration that carries out a promotion program in the electronic receipt system according to an embodiment.

FIG. 13 illustrates a functional configuration that provides electronic receipt information in the electronic receipt system according to an embodiment.

FIG. 14 illustrates a functional configuration that performs a report output in the electronic receipt system according to an embodiment.

FIG. 15 illustrates an example of a conversion report generated through the report output.

FIG. 16 illustrates another example of the conversion report.

FIG. 17 is a sequence diagram of processing to carry out the promotion program according to an embodiment.

FIG. 18 is a sequence diagram of processing to provide the electronic receipt information according to an embodiment.

FIG. 19 is a flowchart of processing to perform the report output according to an embodiment.

FIG. 20 illustrates an overall configuration of an electronic receipt system according to a first modification example.

FIG. 21 is a block diagram of a signage terminal in the electronic receipt system according to the first modification example.

FIG. 22 illustrates an overall configuration of an electronic receipt system according to a second modification example.

FIG. 23 is a block diagram of a user terminal in the electronic receipt system according to the second modification example.

FIG. 24 illustrates an overall configuration of an electronic receipt system according to a third modification example.

FIG. 25 is a block diagram of a user terminal in the electronic receipt system according to the third modification example.

### DETAILED DESCRIPTION

In general, according to one embodiment, a system is for tracking effectiveness of electronic promotions distributed to a plurality of mobile computing devices over a network. The system includes a promotion distribution unit and a central management server. The promotion distribution unit is configured to distribute content of the promotions to mobile computing devices of users, each of the promotions having a promotion ID and a product ID associated therewith, and to transmit the promotion ID and the associated product ID of each of the promotions to a central management server. The central management server is configured to store in a first table, the promotion IDs and the products IDs in association with each other, to store in a second table, a promotion ID, a user ID, and a promotion viewing time in association with each other, upon receiving confirmation from a mobile computing device correlated to the user ID that content of a promotion having the promotion ID has been viewed using the mobile computing device at the promotion viewing time, and to store electronic receipt data that have been generated as a result of purchases of products and transmitted to the central management server, the electronic receipt data for each purchase of a product including a product ID of the product purchased, a user ID of the user who purchased the product, and a time of the purchase. The central management server is further configured to compute an effectiveness value for each of the promotions, based on the first and second tables and the electronic receipt data. The effectiveness value for a promotion is incremented for purchase of a product associated with the promotion by a user after the user has viewed content of the promotion.

An embodiment will be described with reference to drawings.

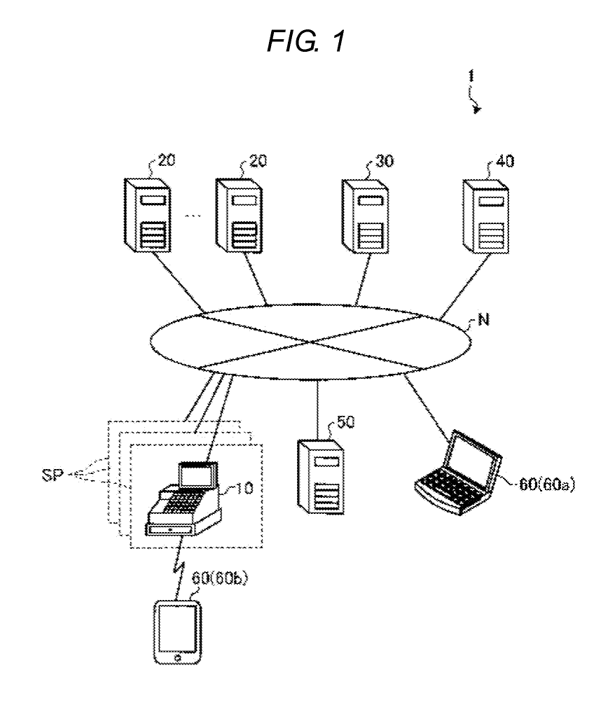

FIG. 1 illustrates an overall configuration of an electronic receipt system 1 according to the embodiment. As shown in FIG. 1, the electronic receipt system 1 includes a POS terminal 10, an electronic receipt server 20, a management server 30, a promotion server 40, an information provision server 50, and a user terminal 60. Here, the respective devices that configure the electronic receipt system 1 are connected to a network N, such as the Internet, in a wireless or wired manner.

Hereinafter, the respective devices that configure the electronic receipt system 1 will be described.

### POS Terminal

First, the POS terminal 10 will be described. The POS terminal 10 is a merchandise sales data processing device and executes merchandise sales data processing. The POS terminal 10 is located at a store SP such as a supermarket or a convenience store, for example.

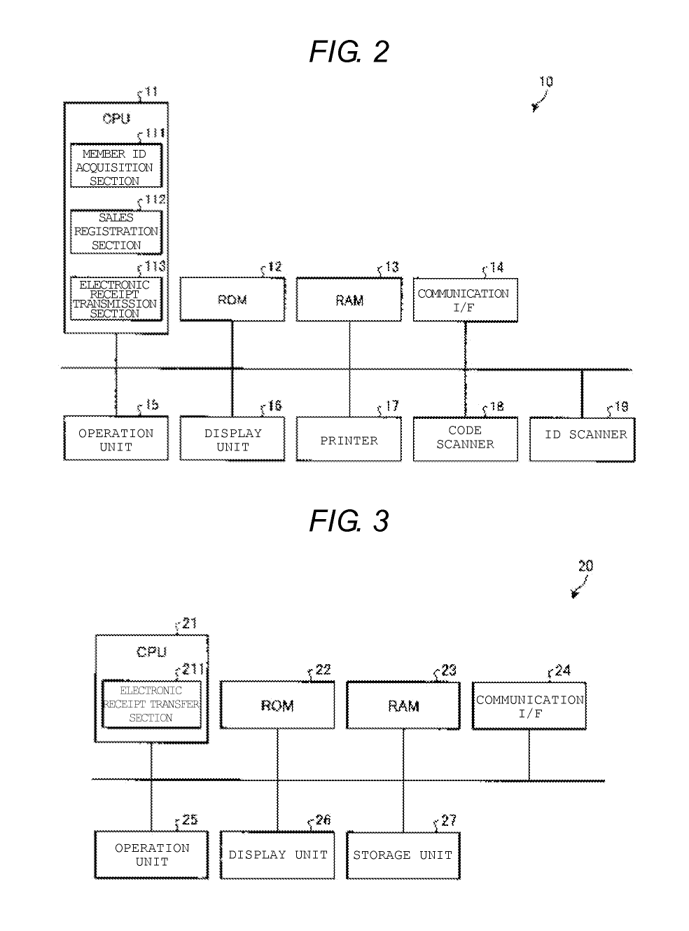

FIG. 2 is a block diagram of the POS terminal 10. As shown in FIG. 2, the POS terminal 10 includes a Central Processing unit (CPU) 11, a Read Only Memory (ROM) 12, a Random Access Memory (RAM) 13, a communication I/F 14, an operation unit 15, a display unit 16, a printer 17, a code scanner 18, and an ID scanner 19. In addition, the POS terminal 10 includes a time indicating device (not shown) such as a Real Time Clock (RTC).

The ROM 12 stores various programs executed by the CPU 11 and various data. The RAM 13 temporarily stores data and programs when the CPU 11 executes various programs. The CPU 11 generates functional units, such as a member ID acquisition section 111, a sales registration section 112, and an electronic receipt transmission section 113 by developing and executing the various programs, which are stored on the ROM 12, in the RAM 13. Details of the functional units will be described below.

The communication I/F 14 is a communication interface capable of being connected to the network N. The POS terminal 10 may communicate with devices connected to the network N via the communication I/F 14.

The operation unit 15 is an input device such as a keyboard or a pointing device. Such a keyboard includes numerical keypad, keys of arithmetic operators, and an enter key for instructing completion of a transaction. The operation unit 15 receives operational inputs by an operator and outputs content of the operations to the CPU 11.

The display unit 16 is a display device such as a Liquid Crystal Display (LCD). The display unit 16 displays various kinds of information, including content of transactions, under control of the CPU 11. In addition, the display unit 16 may include a display device for customers and a display device for the operator. Moreover, the display unit 16 may be configured as a touch panel. In such a case, the touch panel functions as the operation unit 15.

The printer 17 is a printing device that performs printing on sheet such as receipt sheet. The printer 17 prints content of a transaction on sheet under control of the CPU 11.

The code scanner 18 is a reading device that reads code symbols such as barcodes. The code scanner 18 reads code symbols printed on merchandise and outputs merchandise IDs contained in the code symbols to the CPU 11. Here, the merchandise IDs are merchandise identifiers for identifying the respective merchandises, such as JAN codes.

The ID scanner 19 is a reading device that reads member IDs assigned to customers (members). Here, the member IDs are unique identifies that are assigned to customers who registered as members. Such member IDs are stored in storage media, such as magnetic cards, IC cards, or user terminals 60b, that are owned by the members.

The ID scanner 19 reads member IDs from storage media that customers present and outputs the member IDs to the CPU 11. Here, a method of reading the member IDs is not particularly limited. If the member IDs are contained in magnetic cards, for example, a magnetic card reader may be used as the ID scanner 19. If the member IDs are contained in IC cards, an IC card reader may be used as the ID scanner 19. If the member IDs are contained in the user terminals 60b, a communication device capable of communicating with the user terminals 60b by a communication scheme such as Near Field Communication (NFC) maybe used as the ID scanner 19. If member IDs are displayed as code symbols on paper media or display screens of the user terminals 60b, the code scanner 18 may be used as the ID scanner 19.

The POS terminal 10 performs sales registration of merchandises that customers have purchased. In addition, the POS terminal 10 transmits electronic receipt information including details of merchandises purchased in a purchase transaction along with a member ID of a customer to the electronic receipt server 20. The electronic receipt information specifically includes merchandise IDs of the purchased merchandises, purchase dates and time, and a purchase place (store). In addition, the POS terminal 10 outputs, from the printer 17, details of the merchandises purchased in a purchase transaction in response to a request from a customer, for example.

### Electronic Receipt Server

Next, the electronic receipt server 20 will be described. The electronic receipt server 20 is provided for a company which runs one or more stores SP. The electronic receipt server 20 functions as a receipt management server for a company, which manages electronic receipt information of the company. In addition, a head office server of POS systems, which has functions of managing sales, analyzing sales, managing stock, and the like for the company may be used as the electronic receipt server 20.

FIG. 3 is a block diagram of the electronic receipt server 20. As shown in FIG. 3, the electronic receipt server 20 includes a CPU 21, a ROM 22, a RAM 23, a communication I/F 24, an operation unit 25, a display unit 26, and a storage unit 27. In addition, the electronic receipt server 20 includes a time indicating device (not shown) such as an RTC.

The ROM 22 stores various programs executed by the CPU 21 and various data. The RAM 23 temporarily stores data and programs when the CPU 21 executes the various programs. The CPU 21 generates functional units such as an electronic receipt transfer section 211 by developing and executing the various programs, which are stored on the ROM 22 or the storage unit 27, in the RAM 23. Details of the functional units will be described below.

The communication I/F 24 is a communication interface capable of being connected to the network N. The electronic receipt server 20 may communicate with devices, which are connected to the network N, via the communication I/F 24. The operation unit 25 is an input device such as a keyboard or a pointing device. The operation unit 25 receives operations of the operator and outputs content of the operations to the CPU 21. The display unit 26 is a display device such as an LCD. The display unit 26 displays various kinds of information under control of the CPU 21.

The storage unit 27 is a storage device such as a Hard Disc Drive (HDD) or a Solid State Drive (SSD). The storage unit 27 stores various programs executed by the CPU 21 and various data.

The electronic receipt server 20 transfers the electronic receipt information and the member IDs, which are transmitted from the POS terminal 10 at the store SP that is managed by the electronic receipt server 20 itself, to the management server 30.

### Management Server

Next, the management server 30 will be described. The management server 30 is a server device that collectively manages electronic receipt information of multiple companies each of which runs one or more stores. The management server 30 is managed by a third party, for example, other than the company which manages the electronic receipt information using the electronic receipt server 20. Alternatively, not only the management server 30 but also the electronic receipt server 20 may be also managed by a third party or the like.

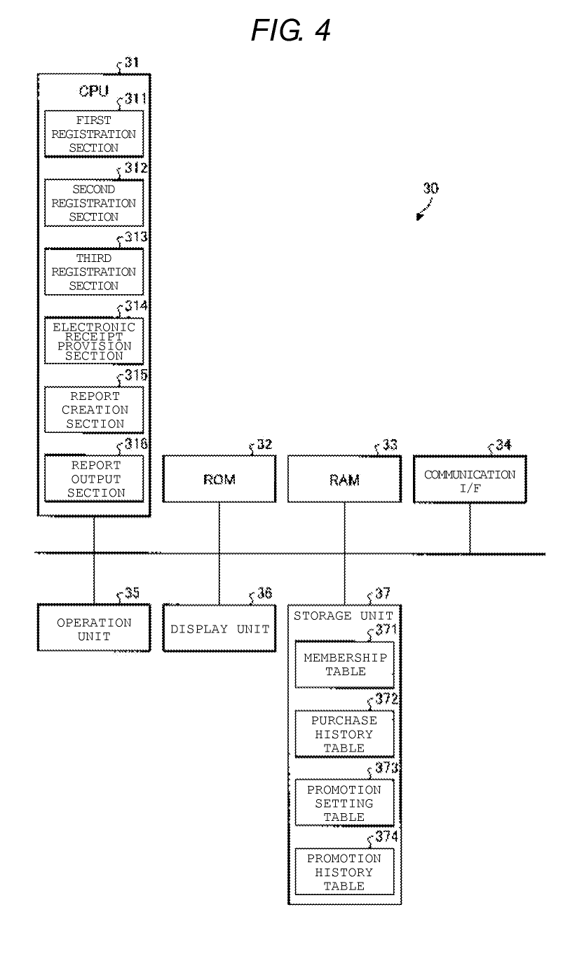

FIG. 4 is a block diagram of the management server 30. As shown in FIG. 4, the management server 30 includes a CPU 31, a ROM 32, a RAM 33, a communication I/F 34, an operation unit 35, a display unit 36, and a storage unit 37. In addition, the management server 30 includes a time indicating device (not shown) such as an RTC.

The ROM 32 stores various programs executed by the CPU 31 and various data. The RAM 33 temporarily stores data and programs when the CPU 31 executes the various programs. The CPU 31 generates functional units such as a first registration section 311, a second registration section 312, a third registration section 313, an electronic receipt provision section 314, a report creation section 315, and a report output section 316 by developing and executing the various programs, which are stored on the ROM 32 or the storage unit 37, in the RAM 33. Details of the functional units will be described below.

The communication I/F 34 is a communication interface capable of being connected to the network N. The management server 30 may communicate with the devices, which are connected to the network N, via the communication I/F 34. The operation unit 35 is an input device such as a keyboard or a pointing device. The operation unit 35 receives operations of the operator and outputs content of the operations to the CPU 31. The display unit 36 is a display device such as an LCD. The display unit 36 displays various kinds of information under control of the CPU 31.

The storage unit 37 is a storage device such as an HDD or an SSD. The storage unit 37 stores various programs executed by the CPU 31 and various data. In addition, the storage unit 37 stores a table (database) for storing various data relating to the system. Examples of such a table include a membership table 371, a purchase history table 372, a promotion setting table 373, and a promotion history table 374.

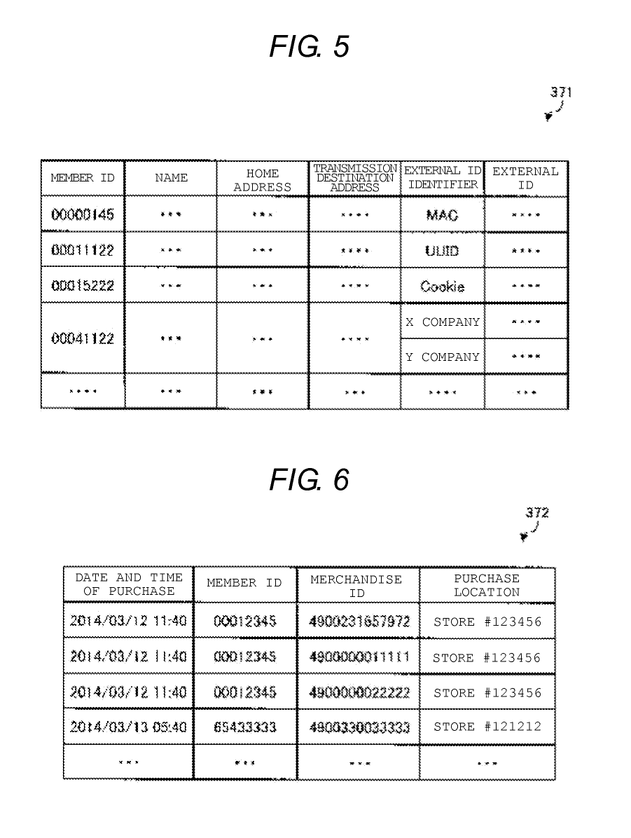

The membership table 371 is a data table for managing information (membership information) relating to customers (members) which have registered as members. FIG. 5 illustrates a data configuration of the membership table 371. As shown in FIG. 5, the membership table 371 includes sections for saving member IDs, names, home addresses, destination addresses, external ID identifiers, and external IDs.

Here, in the section for member IDs, unique character strings, numerical values, or the like assigned in membership registration are stored. In the sections for names and home addresses, names and home addresses that the members input during the membership registration are stored. In the section for destination addresses, address information such as email addresses as destinations of electronic receipts is stored.

In the section for external IDs, identifiers (hereinafter, referred to as external IDs) other than member IDs of the members are stored. As the external IDs, MAC addresses (MAC), Universally Unique Identifier (UUID), session IDs (Cookie), or the like of the user terminals 60 owned by the members, for example, are stored. If a member of the present system is also a member of a system other than the present system, a name of company which provides the system other than the present system, for example, is stored.

Among the membership information, the member IDs are registered during the membership registration. In addition, the names, the home addresses, the destination addresses, the external ID identifiers, and the external IDs maybe registered during or after the membership registration. As a method of registering the external ID identifiers and the external IDs, various registration methods may be employed. For example, there is a case where promotion history information, which is transmitted from the information provision server 50 or the user terminal 60, includes the member IDs and the external IDs (external ID identifiers). In such a case, the management server 30 may register the external IDs (external ID identifiers), which are received along with the member IDs, in the membership table 371 in association with the corresponding member IDs.

Here, the data configuration of the membership table 371 is not limited to the example illustrated in FIG. 5. There maybe members for which some or all of the sections for names, home addresses, destination addresses, external ID identifiers, and external IDs are blank.

The purchase history table 372 is a data table for managing electronic receipt information. FIG. 6 illustrates a data configuration of the purchase history table 372. As shown in FIG. 6, the purchase history table 372 includes sections for storing purchase dates and time, member IDs, merchandise IDs, and purchase places, which are included in the electronic receipt information. Here, in the section for purchase places, a store ID of the store SP where sales registration has been performed is stored, for example.

The management server 30 receives the electronic receipt information and the member IDs from the electronic receipt server 20 and then registers the information in the purchase history table 372. Although, according to the present embodiment, the electronic receipt information is received via the electronic receipt server 20, the electronic receipt information may be directly received from each POS terminal 10.

In addition, the management server 30 provides the electronic receipt information associated with a member ID of a specific customer to a destination address associated with the member ID, in response to a request from the customer, for example.

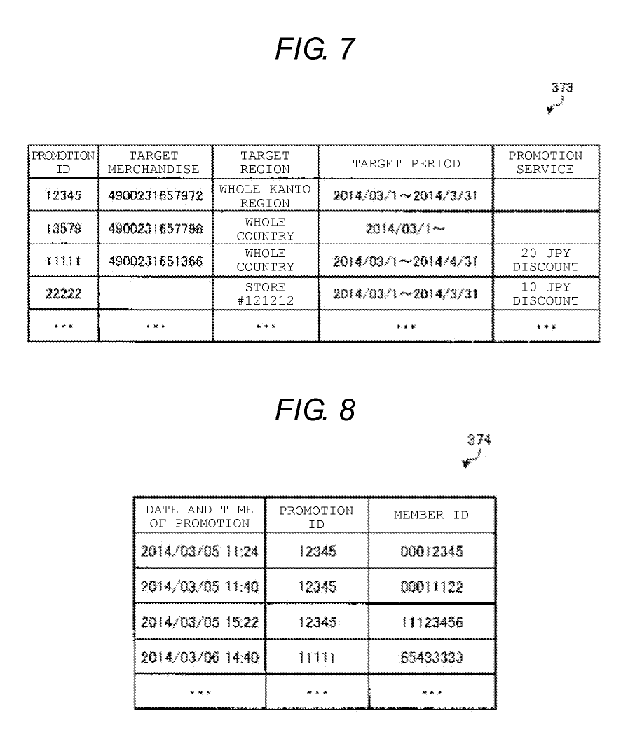

The promotion setting table 373 is a data table for managing setting information (promotion setting information) relating to sales promotion (promotion). FIG. 7 illustrates a data configuration of the promotion setting table 373. As shown in FIG. 7, the promotion setting table 373 includes sections for saving promotion IDs, target merchandises, target areas (store), target periods, and promotion services.

In the section for promotion IDs, character strings or numerical values for identifying a promotion program are stored. In the section for target merchandises, merchandise IDs of merchandises, as targets of a promotion program, are stored. In the section for target areas, geographic areas or stores (store IDs) of the promotion program are stored. In the section for target periods, periods of the promotion program are stored. In the section for promotion services, content of services to be provided to customers who purchase the target merchandises during the target periods or customers who use stores in the target areas are stored. Here, examples of the content of the services include price discount, for example. A specific store of chain stores may be set as a target of the promotion program. In this case, the section for target merchandise is left as blank, and a store ID of the specific store is stored in the section for target areas.

The management server 30 receives the promotion setting information from the promotion server 40, which will be described below, and then registers various information items included in the promotion setting information in the promotion setting table 373.

The promotion history table 374 is a data table for managing information (promotion history information) relating to customers who have acquired promotion information (described below). FIG. 8 illustrates aa data configuration of the promotion history table 374. As shown in FIG. 8, the promotion history table 374 includes sections for saving promotion dates and time, promotion IDs, and member IDs.

Here, in the section for promotion dates and time, dates and time when the customers acquire the promotion information are stored. In the section for promotion IDs, promotion IDs corresponding to the promotion information that the customers have acquired are stored. In the section for member IDs, member IDs of the customers who have acquired the promotion information are stored.

The management server 30 receives the promotion history information from the information provision server 50 or the user terminal 60, and then registers various information items included in the promotion history information in the promotion history table 374.

According to the present embodiment, member IDs may not be included in the transmitted promotion history information, and external IDs and external ID identifiers may be included instead. In such a case, the management server 30 (CPU 31) refers to the membership table 371 and performs registration in the promotion history table 374 using member IDs corresponding to the external IDs. If there are no corresponding IDs in the membership table 371, the registration in the promotion history table 374 may be performed by leaving the section for the member IDs as blank.

As described above, the management server 30 (CPU 31) functions as a management section that associates records of the same customers who have been registered with different identifiers in the respective tables if a plurality of identifiers (member IDs and external IDs) of the same customer are registered in the membership table 371. As the customer (member) may use the system by using any of the plurality of identifiers (member IDs and external IDs) that the customer own, opportunities that the customers use the system may increase.

In addition, the management server 30 generates a conversion report (described below), which represents effects of the promotion program, based on the information saved on the respective tables. Then, the management server 30 outputs the generated conversion report to a predetermined output destination.

### Promotion Server

Next, the promotion server 40 will be described. The promotion server 40 is a server device that manages promotion programs such as distribution of advertisement. The promotion server 40 is managed by a company which manufactures or sells merchandise or an advertising agency which creates advertisement, for example.

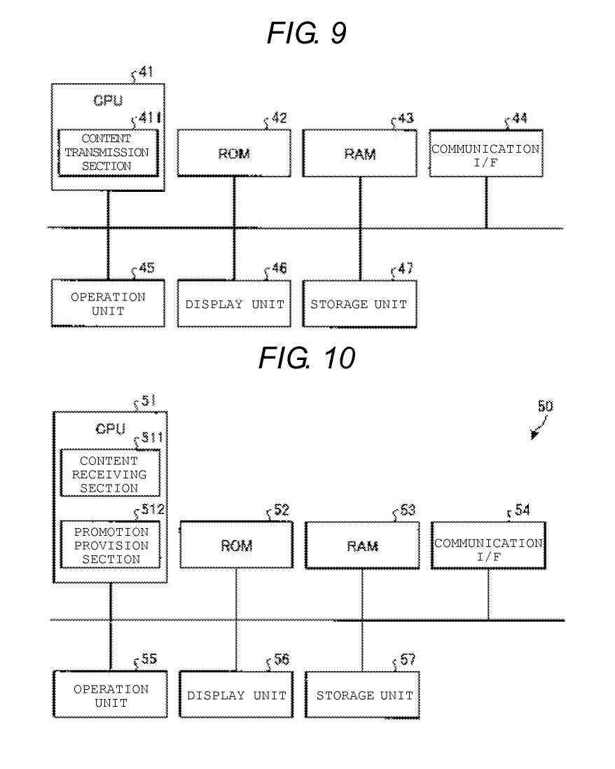

FIG. 9 is a block diagram of the promotion server 40. As shown in FIG. 9, the promotion server 40 includes a CPU 41, a ROM 42, a RAM 43, a communication I/F 44, an operation unit 45, a display unit 46, and a storage unit 47. In addition, the promotion server 40 includes a time indicating device (not shown) such as an RTC.

The ROM 42 stores various programs executed by the CPU 41 and various data. The RAM 43 temporarily stores data and programs when the CPU 41 executes the various programs. The CPU 41 generates functional units such as a content transmission section 411 by developing and executing the various programs, which are stored on the ROM 42 or the storage unit 47, in the RAM 43. Details of the functional units will be described below.

The communication I/F 44 is a communication interface connectable to the network N. The promotion server 40 may communicate with the devices, which are connected to the network N, via the communication I/F 44. The operation unit 45 is an input device such as a keyboard or a pointing device. The operation unit 45 receives operations of the operator and outputs content of the operations to the CPU 41. The display unit 46 is a display device such as an LCD. The display unit 46 displays various kinds of information under control of the CPU 41.

The storage unit 47 is a storage device such as an HDD or an SSD. The storage unit 47 stores various programs executed by the CPU 41 and various date. In addition, the storage unit 47 stores the promotion information and the promotion setting information (not shown).

Here, the promotion information is information such as advertisement for promoting a specific product, a specific store, or the like. For example, the promotion information includes content such as character data or images (stationary images or video images) for promotion. In addition, the promotion information includes a promotion ID assigned thereto.

The promotion setting information is setting information which defines conditions and the like for providing the promotion information. Specifically, the promotion setting information includes information relating to promotion IDs, target merchandise, target areas, target periods, and services, as described above with reference to FIG. 7. In addition, the same promotion ID is assigned to corresponding promotion information and promotion setting information.

The promotion server 40 transmits the promotion information and the corresponding promotion setting information to the information provision server 50. In addition, the promotion server 40 transmits the promotion setting information to the management server 30.

### Information Provision Server

Next, the information provision server 50 will be described. The information provision server 50 is a server device that provides the promotion information via the Internet media.

FIG. 10 is a block diagram of the information provision server 50. As shown in FIG. 10, the information provision server 50 includes a CPU 51, a ROM 52, a RAM 53, a communication I/F 54, an operation unit 55, a display unit 56, and a storage unit 57. In addition, the information provision server 50 includes a time indicating device (not shown) such as an RTC.

The ROM 52 stores various programs executed by the CPU 51 and various data. The RAM 53 temporarily stores data and programs when the CPU 51 executes the various programs. The CPU 51 generates functional units such as a content receiving section 511 and a promotion provision section 512 by developing and executing the various programs, which are stored on the ROM 52 and the storage unit 57, in the RAM 53. Details of the functional units will be described below.

The communication I/F 54 is a communication interface capable of being connected to the network N. The information provision server 50 may communicate with the devices, which are connected to the network N, via the communication I/F 54. The operation unit 55 is an input device such as a keyboard or a pointing device. The operation unit 55 receives operations of the operator and outputs content of the operations to the CPU 51. The display unit 56 is a display device such as an LCD. The display unit 56 displays various kinds of information under control of the CPU 51.

The storage unit 57 is a storage device such as an HDD or an SSD. The storage unit 57 stores various programs executed by the CPU 51 and various data. In addition, the storage unit 57 stores the promotion information and the promotion setting information transmitted from the promotion server 40.

The information provision server 50 receives the promotion information and the promotion setting information from the promotion server 40. In addition, the information provision server 50 provides the promotion information, to which the same promotion ID as that of the promotion setting information is assigned, to the user terminal 60 in accordance with the content of the promotion setting information.

Here, a method of providing the promotion information is not particularly limited. For example, the promotion information may be provided via a web page using a web server as the information provision server 50. Alternatively, the promotion information may be provided via an email using an email server as the information provision server 50. Alternatively, the promotion information may be provided as a video image using a video image distribution server as the information provision server 50.

### User Terminal

Next, the user terminal 60 will be described. The user terminal 60 is a terminal device that the customer who uses the electronic receipt system 1 owns. Examples of the user terminal 60 include a non-portable user terminal 60a, such as a home personal computer (PC), and a portable user terminal 60b, such as a mobile phone.

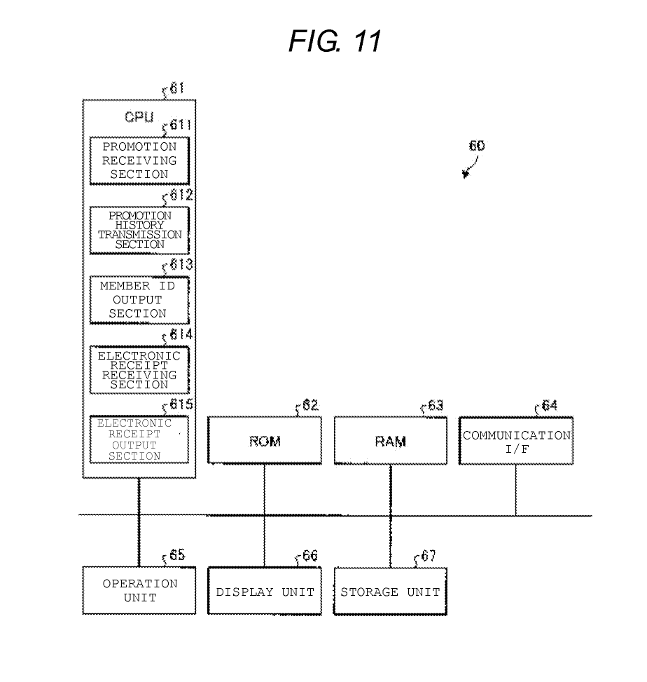

FIG. 11 is a block diagram of the user terminal 60. As shown in FIG. 11, the user terminal 60 includes a CPU 61, a ROM 62, a RAM 63, a communication I/F 64, an operation unit 65, a display unit 66, and a storage unit 67. In addition, the user terminal 60 includes a time indicating device (not shown) such as an RTC.

The ROM 62 stores various programs executed by the CPU 61 and various data. The RAM 63 temporarily stores data and programs when the CPU 61 executes the various programs. The CPU 61 generates functional units such as a promotion receiving section 611, a promotion history transmission section 612, a member ID output section 613, an electronic receipt receiving section 614, and an electronic receipt output section 615 by developing and executing the various programs, which are stored on the ROM 62 and the storage unit 67, in the RAM 63. Details of the functional units will be described below.

The communication I/F 64 is a communication interface capable of being connected to the network N. The user terminal 60 may communicate with the devices, which are connected to the network N, via the communication I/F 64. In addition, a communication interface capable of performing short-distance communication such as NFC may be provided as the communication I/F 64.

The operation unit 65 is an input device such as a keyboard or a pointing device. The operation unit 65 receives operations of the operator and outputs content of the operations to the CPU 61. The display unit 66 is a display device such as an LCD. The display unit 66 displays various kinds of information under control of the CPU 61.

The storage unit 67 is a storage device such as an HDD or an SSD. The storage unit 67 stores various programs executed by the CPU 61 and various data . For examples, the storage unit 67 stores programs for web browsers, email clients, and the like. In addition, the storage unit 67 stores the member IDs, external IDs, and the like.

The user terminal 60 acquires the promotion information from the information provision server 50 and then transmits the promotion history information, which indicates that the user terminal 60 has acquired the promotion information, to the management server 30. Such promotion history information includes a date and time (promotion date and time) when the promotion information was acquired, the promotion ID included in the promotion information, the member ID, and the external ID (external ID identifier). Here, the member ID and the external ID are transmitted to the management server in accordance with a command (program) embedded in the promotion information. In addition, the promotion history information may be transmitted to the management server 30 via the information provision server 50.

In addition, the user terminal 60 (60b) performs proximity communication with the ID scanner 19 of the POS terminal 10 and transmits information such as the member ID to the POS terminal 10. If the user terminal 60b has electronic payment function, by which electronic payment may be performed, the user terminal 60b may transmit electronic payment information to the POS terminal 10.

In addition, the user terminal 60 acquires the electronic receipt information from the management server 30 and outputs it to the display unit 66 and the like. Here, a method of acquiring the electronic receipt information is not particularly limited. For example, a pull-type acquisition method of transmitting an acquisition request with a designated member ID from the user terminal 60 to the management server may be employed to acquire the electronic receipt information. Alternatively, a push-type acquisition method of acquiring the electronic receipt information that is automatically provided (distributed) from the management server 30 may be employed. In both cases, an email address or the like of the user terminal 60 is registered in the section for the destination address in the membership table 371.

Next, functional configurations of the aforementioned respective devices will be described.

### Promotion Function

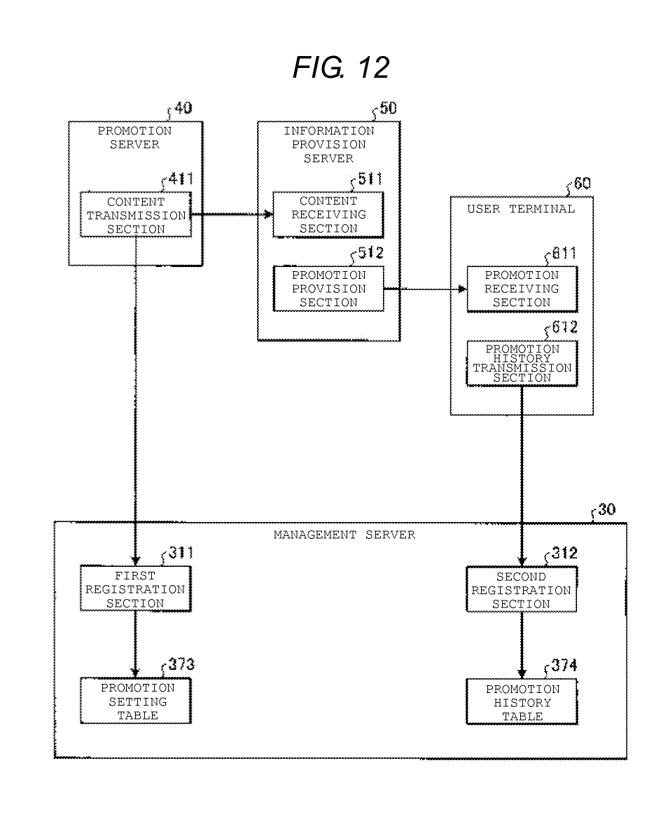

First, a functional configuration to carry out the promotion program, through which the promotion information is provided and the promotion history information is collected, will be described. FIG. 12 illustrates a functional configuration to carry out the promotion program in the electronic receipt system 1.

As shown in FIG. 12, the promotion server 40 includes the content transmission section 411 as a functional unit. In addition, the information provision server 50 includes the content receiving section 511 and the promotion provision section 512 as functional units. Moreover, the user terminal 60 includes the promotion receiving section 611 and the promotion history transmission section 612 as functional units. Furthermore, the management server 30 includes the first registration section 311 and the second registration section 312 as functional units.

The content transmission section 411 of the promotion server 40 reads the promotion information and the promotion setting information, with which the same promotion ID is associated, from the storage unit 47 and transmits the promotion information and the promotion setting information to the information provision server 50. In addition, the content transmission section 411 transmits the promotion setting information to the management server 30.

Here, a timing at which the promotion server 40 transmits the promotion information and the promotion setting information is not particularly limited. For example, the promotion information and the promotion setting information maybe transmitted at a timing when such information is stored on the storage unit 47, or alternatively, the promotion information and the promotion setting information may be transmitted at a predetermined timing. Further alternatively, the promotion information and the promotion setting information may be transmitted in response to an operation of the operator via the operation unit 45. In addition, the transmission to the management server 30 and the transmission to the information provision server 50 may be performed at the same time or at different timings.

The first registration section 311 of the management server 30 receives the promotion setting information transmitted from the promotion server 40. In addition, the first registration section 311 registers various information items, which is included in the received promotion setting information, in corresponding sections of the promotion setting table 373 (see FIG. 7).

The content receiving section 511 of the information provision server 50 receives the promotion information and the promotion setting information from the promotion server 40. In addition, the content receiving section 511 stores the received promotion information and the promotion setting information on the storage unit 57.

The promotion provision section 512 of the information provision server 50 provides the promotion information, with which the same promotion ID as that of the promotion setting information is associated, to the user terminal 60 based on the promotion setting information. Here, a method of providing the promotion information is not particularly limited, and for example, it is possible to use a web page, an email, video image distribution, or the like as described above.

Here, provision of the promotion program may be limited in accordance with a condition set in the promotion setting information. For example, if a specific period (target period) is set in the promotion setting information, the promotion provision section 512 limits a period, during which the promotion information is provided, based on the target period. If a specific region (target region) is set in the promotion setting information, the promotion provision section 512 operates such that the promotion information is provided to the user terminal 60 which accesses from the target region. Here, a method of limiting the target region is not particularly limited, and known official techniques maybe used. For example, the region as the target of providing the promotion information may be limited by cooperating with a provider which provides a route for providing the promotion information. Alternatively, position information (GPS information) indicating a position at which the user terminal 60 is located may be acquired from the user terminal 60 which accesses the information provision server 50, and the region as a target of providing the promotion information may be limited based on the position at which the user terminal 60 is located.

In addition, the promotion provision section 512 adds additional information, which is for causing the user terminal 60 or the customer who operates the user terminal 60 to perform a predetermined operation, to the promotion information and sends the additional information. The additional information includes first information for acquiring an identifier of the customer as a provision target and second information for transmitting the promotion history information to the management server 30. Moreover, a method of causing the predetermined operation is not particularly limited, and known and official techniques may be used.

For example, the first information may be a program such as a script for automatically acquiring the member ID, the external ID, or the like of the user terminal 60. In addition, the first information may be an input form or the like for allowing the customer to input their member ID, the external ID, or the like. An identifier as a target of the acquisition is a MAC address, UUID, a member ID for another service, or an external ID (external ID type) such as a session ID (Cookie) as well as the aforementioned member ID. The customer and the member ID or the external ID may be acquired only when the customer permits the acquisition. If the permission of the acquisition of the member ID or the external ID is set in advance, the member ID or the external ID is automatically acquired without the confirmation with the customer.

For example, the second information maybe a program such as a script for automatically transmitting the promotion history information. In addition, the second information may be a transmission form or the like for allowing the customer to transmit the promotion history information. The customer and the promotion history information may be transmitted only when the customer permits the transmission. If the permission of the transmission of the promotion history information is set, the promotion history information is automatically transmitted without the confirmation with the customer. The promotion history information includes a date and time when the promotion information was acquired and a promotion ID included in the promotion information as well as the member ID and the external ID (external ID type).

The user terminal 60 that acquired the promotion information transmits the promotion history information, which indicates that the user terminal 60 has acquired the promotion information, to the management server 30 by the second information. Alternatively, the information provision server 50 may collect the promotion history information from the user terminal 60, and the promotion history information may be transmitted to the management server 30 via the information provision server 50. Moreover, the promotion information may be transmitted as it is if the promotion information provided from the promotion server 40 includes, in advance, information corresponding to the aforementioned additional information.

The promotion receiving section 611 of the user terminal 60 receives (acquires) the promotion information and the additional information from the information provision server 50. If the promotion information is provided in a web page or a video image, for example, the promotion receiving section 611 cooperates with a program such as a web browser to acquire the promotion information. If the promotion information is provided through an email, the promotion receiving section 611 cooperates with a program such as an email client to acquire the promotion information.

The promotion history transmission section 612 of the user terminal 60 transmits the promotion history information, which indicates that the user terminal 60 has acquired the promotion information, to the management server 30. More specifically, the promotion history transmission section 612 acquires various information items (a date and time of the promotion, the promotion ID, the member ID, the external ID, and the like) that configure the promotion history information based on the additional information received along with the promotion information. In addition, the promotion history transmission section 612 transmits the promotion history information to the management server 30 based on the additional information.

If the promotion history transmission section 612 acquires both or one of the member ID and the external ID, the promotion history transmission section 612 transmits the acquired IDs so as to be included in the promotion history information. If the promotion history transmission section 612 can acquire neither of the member ID and the external ID, the promotion history transmission section 612 transmits the promotion history information that includes the date and time of the promotion and the promotion ID.

A timing at which the promotion history information is transmitted is not particularly limited. For example, the promotion history information may be transmitted when the promotion information is acquired. If the promotion information is a video image, the promotion history information may be transmitted at a timing at which replay of the video image is started or a timing at which a replay end time is reached. Alternatively, the promotion history information may be transmitted in response to an operation of the user (customer).

The second registration section 312 of the management server 30 receives the promotion history information transmitted from the user terminal 60. In addition, the second registration section 312 registers various information items, which are included in the received promotion history information, in corresponding sections in the promotion history table 374 (see FIG. 8).

### Electronic Receipt Function

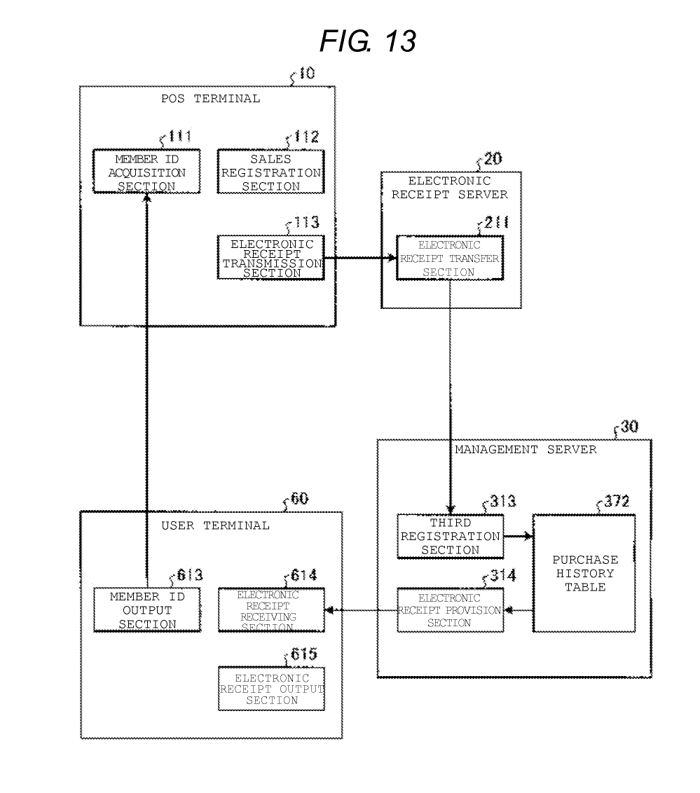

Next, a functional configuration to carry out provision of the electronic receipt information will be described. FIG. 13 illustrates a functional configuration to provide the electronic receipt information in the electronic receipt system 1.

As shown in FIG. 13, the POS terminal 10 includes a member ID acquisition section 111 and an electronic receipt transmission section 113 as functional units. The electronic receipt server 20 includes an electronic receipt transfer section 211 as a functional unit. The management server 30 includes a third registration section 313 and an electronic receipt provision section 314 as functional units. Moreover, the user terminal 60 includes a member ID output section 613, an electronic receipt receiving section 614, and an electronic receipt output section 615 as functional units.

The member ID acquisition section 111 of the POS terminal 10 acquires a member ID from the user terminal 60b, for example, owned by the customer via the ID scanner 19.

The member ID output section 613 of the user terminal 60b communicates with the member ID acquisition section 111 via the communication I/F 64 or the like and outputs the member ID owned by the user terminal itself to the POS terminal 10. In addition, a target of acquisition of the member ID is not limited to the user terminal 60b and may be a magnetic card, an IC card, or the like. Alternatively, the member ID output section 613 may operate to output the member ID by displaying the member ID as a code symbol on the display unit 66. In such a case, the member ID acquisition section 111 of the POS terminal 10 acquires the member ID via the code scanner 18.

The sales registration section 112 of the POS terminal 10 reads, from a merchandise master (not shown), merchandise information such as a merchandise name and a merchandise sales price corresponding to a merchandise ID read by the code scanner 18 from a merchandise, and performs sales registration of the merchandise using the merchandise information. In addition, the sales registration section 112 provides a service such as discount to customers (or members) if provision of the promotion service is set for the merchandise or a store at which the transaction is performed. Here, the promotion service set in the POS terminal 10 is based on content of the promotion setting information. Here, since merchandise sales data processing relating to the merchandise sales registration is the same as the existing technique, the description thereof will be omitted.

The electronic receipt transmission section 113 of the POS terminal 10 transmits the electronic receipt information, which includes details of merchandises purchased in the transaction registered by the sales registration section 112, to the electronic receipt server 20. More specifically, the electronic receipt transmission section 113 transmits a merchandise ID of each merchandise subjected to sales registration, a date and time (a date and time of purchase) when the sales registration has been completed, a member ID acquired by the member ID acquisition section 111, and a store ID set in advance in the electronic receipt transmission section 113, as electronic receipt information, to the management server 30. If the member ID is not acquired, the electronic receipt transmission section 113 transmits the electronic receipt information without the member ID.

The electronic receipt transfer section 211 of the electronic receipt server 20 receives the electronic receipt information from the POS terminal 10. In addition, the electronic receipt transfer section 211 transmits (transfers) the received electronic receipt information to the management server 30. A timing at which the electronic receipt information is transferred to the management server 30 is not particularly limited. For example, the electronic receipt information may be transferred every time the electronic receipt information is received. Alternatively, the electronic receipt information corresponding to a predetermined period (one day, for example) may be stored in the storage unit 27, a database, or the like, and the electronic receipt information may be transferred at a predetermined timing.

The third registration section 313 of the management server 30 receives the electronic receipt information transmitted from each electronic receipt server 20. In addition, the third registration section 313 registers various information items, which are included in the received electronic receipt information, in corresponding sections of the purchase history table 372 (see FIG. 6).

The electronic receipt provision section 314 of the management server 30 distributes the electronic receipt information associated with a member ID registered in the membership table 371, to a transmission destination address associated with the member ID. Here, a method of distributing the electronic receipt information is not particularly limited, and the pull type or the push type may be employed. In addition, members who do not desire distribution of electronic receipt information are excluded from distribution targets by registering flag information, which indicates that the members do not desire the distribution, in the membership table 371.

The electronic receipt receiving section 614 of the user terminal 60 receives the electronic receipt information distributed from the management server 30. In addition, the electronic receipt output section 615 of the user terminal 60 outputs, to the display unit 66 or the like, the electronic receipt information received by the electronic receipt receiving section 614.

### Report Output Function

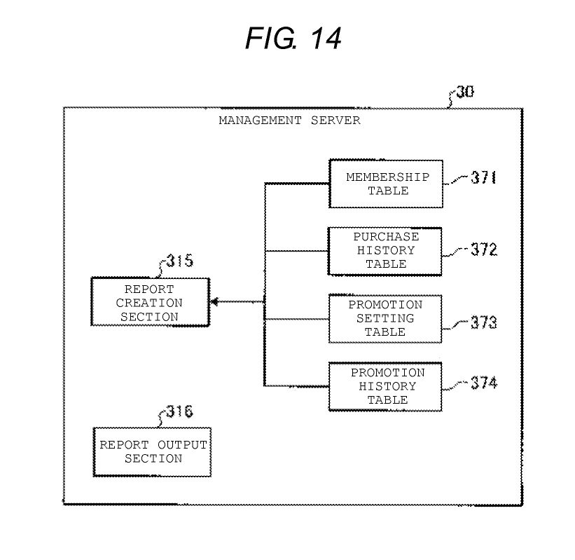

Next, a functional configuration to carry out a report output of a conversion report will be described. FIG. 14 illustrates a functional configuration to carryout the report output in the management server 30.

As shown in FIG. 14, the management server 30 includes a report creation section 315 and a report output section 316 as functional units relating to output of the conversion report.

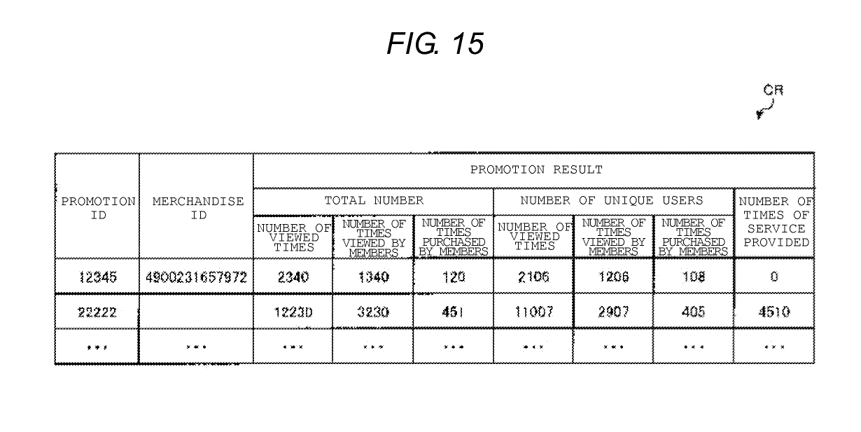

The report creation section 315 creates the conversion report, which indicates result of the promotion program, for each promotion ID based on information stored on each table in the storage section 37. Here, FIG. 15 illustrates an example of the conversion report.

As shown in FIG. 15, a conversion report CR includes a merchandise ID as a target of promotion and result of the promotion are associated, for each promotion ID registered in the promotion setting table 373. Here, the result of the promotion includes classifications of total number, number of unique users, and number of service times.

The classification of total number includes “number of viewed times”, “number of times viewed by members”, and “number of times purchased by members.” In the “number of viewed times”, the total number of times customers have acquired (viewed) the promotion information is input. Specifically, the report creation section 315 refers to the promotion history table 374 and collects the counted numbers therein with respect to each promotion ID. Then, the report creation section 315 inputs a result of the collection to the section for the “number of viewed times” of the corresponding merchandise ID. The “number of viewed times” includes not only members of the system but also non-members. The non-members mean customers to which member IDs are not assigned, namely customers who are not registered in the membership table 371. Alternatively, a target period of the corresponding promotion ID registered in the promotion setting table 373 may be also referred to and the number of data that include the promotion date and time during the target period may be collected.

In the “number of times viewed by members”, the total number of times members of the system acquired the promotion information. Specifically, the report creation section 315 refers to the promotion history table 374 and collects the counted number therein with respect to each promotion ID. Then, the report creation section 315 inputs the result of the collection to the “number of times viewed by members” of the corresponding merchandise ID. Alternatively, a target period of the corresponding promotion ID that is registered in the promotion setting table 373 may be also referred to and the number of data that include the promotion date and time in the target period may be collected.

In the “number of times purchased by members”, the total number of the target merchandise purchased by members. Specifically, the report creation section 315 extracts data, which includes member IDs registered in the promotion history table 374, from the purchase history table 372. In addition, the report creation section 315 collects data which includes a set of a purchase date and time and a merchandise ID that meet conditions of the merchandise ID and the target period set in the promotion setting table 373, from the extracted data. More specifically, dates and time of purchase corresponding to the same merchandise ID, which are included in the target period, are collected. Then, the report creation section 315 inputs the result of the collection to the “number of times purchased by members” of the corresponding merchandise ID. Alternatively, a target region of the corresponding promotion ID that is registered in the promotion setting table 373 may be also referred to and the number of data including purchase locations within the target region may be collected. Here, only purchases made by customers after the customers have viewed the promotional information may be counted for the “number of times purchased by members.” Further, only purchases made by customers with in a predetermined period of time after the customers have viewed the promotional information may be counted.

The number of unique users also includes, “number of viewed times”, “number of times viewed by members”, and “number of times purchased by members.” In the “number of viewed times,” the number of customers (both members and non-members) who have viewed the promotion information is indicated. In the “number of times viewed by members”, the number of members who have viewed the promotion information is indicated. In the “number of times purchased by members”, the number of members who have purchased the target merchandise is indicated.

In the “number of times service provided”, information indicating a total discounted amount when the target merchandise was purchased, for example, is indicated. For example, the report creation section 315 multiples a numerical value represented by content of a service associated with a merchandise ID (or promotion ID) in the promotion setting table 373 by the “number of times purchased by members” as the total discounted amount in relation to the corresponding merchandise ID. If the service provided to the members through the promotional program is “10 JPY discount” and “the number of purchasing by members” is “451”, the report creation section 315 calculates “10×451”. Then, the report creation section 315 inputs the result of the calculation to the “number of times service provided”. In addition, a method of calculating the number of times the service has been provided is not limited to the aforementioned example.

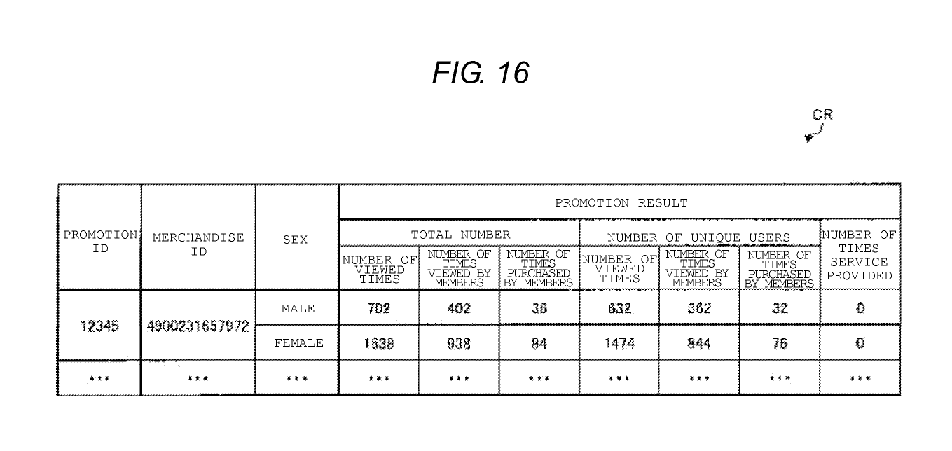

As described above, the report creation section 315 creates the conversion report CR which indicates the number of times the promotion information has been viewed and the results thereof for the customers who use the system. By using the conversion report CR, it is possible to easily recognize the number of target merchandise that may be lead from the promotion program, thereby effectively analyzing the results (effects) of the promotion program. In addition, the data configuration of the conversion report CR is not limited to the example illustrated in FIG. 15. The conversion report CR that includes results of various numbers may be created based on attributes (sexes, generations, and the like) of the respective members who are registered in the membership table 371 as shown in FIG. 16, for example.

FIG. 16 illustrates another example of the conversion report CR, which is created based on sexes of the members. In the conversion report CR, results of the promotion program are indicated for each sex with respect to each promotion ID (merchandise ID). Here, it is assumed that it is possible to acquire electronic receipt information including sexes of non-members by encouraging the customers to input their sexes through the operation section 15 of the POS terminal 10. If the sexes of the non-members are not acquired, a section for “unknown” sexes may be provided, for example, and results of the promotion program with respect to the non-members may be indicated separately. Besides sex (gender), age group (generation group) and other attribute information of customers can be used for generating the conversion report CR.

Returning to FIG. 14, the report output section 316 outputs the conversion report CR created by the report creation section 315. Here, a destination and a method of outputting the conversion report CR are not particularly limited. For example, the display unit 36 included in the management server 30 may output (display) the conversion report CR, or a printer or the like connected to the management server 30 may output (print) the conversion report CR. Alternatively, the conversion report CR may be output (transmitted) to a company (promotion server 40 or the like) which planed the promotion, a company which manufactures or sells the target merchandise, or the like. In addition, the output destination may be switched for each promotion ID.

Hereinafter, operations of the electronic receipt system 1 will be described.

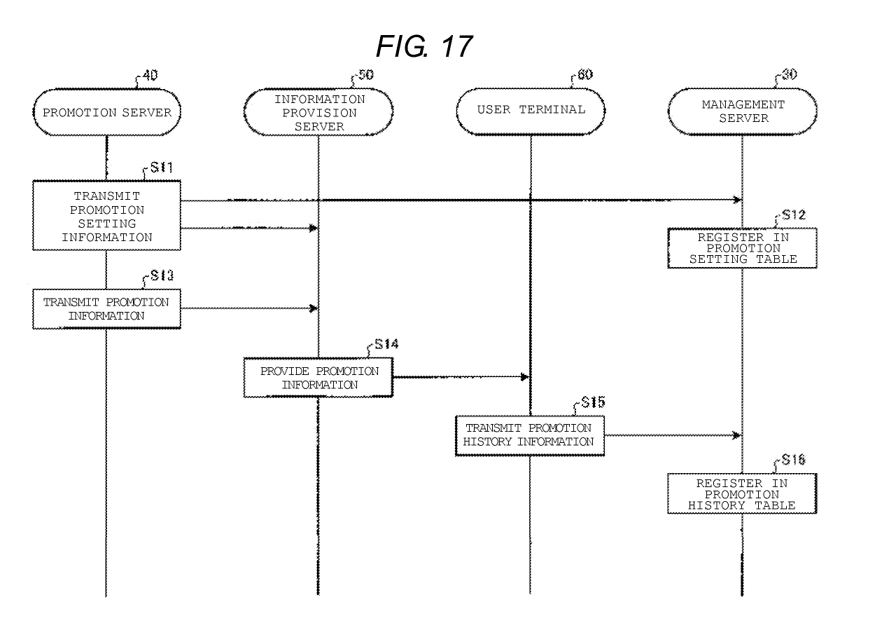

First, operations to carry out the promotion program in the electronic receipt system 1 will be described with reference to FIG. 17. Here, FIG. 17 is a sequence diagram showing an example of the operation to carry out the promotion program in the electronic receipt system 1.

First, the content transmission section 411 of the promotion server 40 transmits the promotion setting information, which is stored in the storage unit 47, to the management server 30 and the information provision server 50 (Step S11). In the management server 30, the first registration section 311 receives the promotion setting information and then registers the promotion setting information in the promotion setting table 373 (Step S12).

Then, the content transmission section 411 of the promotion server 40 transmits the promotion information, with which the same promotion ID as that of the promotion setting information transmitted in Step S11 is associated, to the information provision server 50 (Step S13).

In the information provision server 50, the content receiving section 511 receives the promotion information and the promotion setting information and stores the information in the storage unit 57. Subsequently, the promotion provision section 512 of the information provision server 50 provides the corresponding promotion information along with the additional information to the user terminal 60 based on the promotion setting information (Step S14).

In the user terminal 60, the promotion receiving section 611 receives the promotion information and the additional information and then causes the display unit 66 to display content included in the promotion information. Subsequently, the promotion history transmission section 612 transmits the promotion history information to the management server 30 (Step S15). Then, in the management server 30, the second registration section 312 receives the promotion history information and then registers the promotion history information in the promotion history table 374 (Step S16).

Through the above-descried process, it is possible to register the distribution setting information associated with each promotion ID in the promotion setting table 373 stored in the management server 30. In addition, it is possible to provide the promotion information associated with each promotion ID from the information provision server 50 to the user terminal 60. Furthermore, it is possible to register the history of acquiring the promotion information by each user terminal 60, as the promotion history information, in the promotion history table 374 stored in the management server 30.

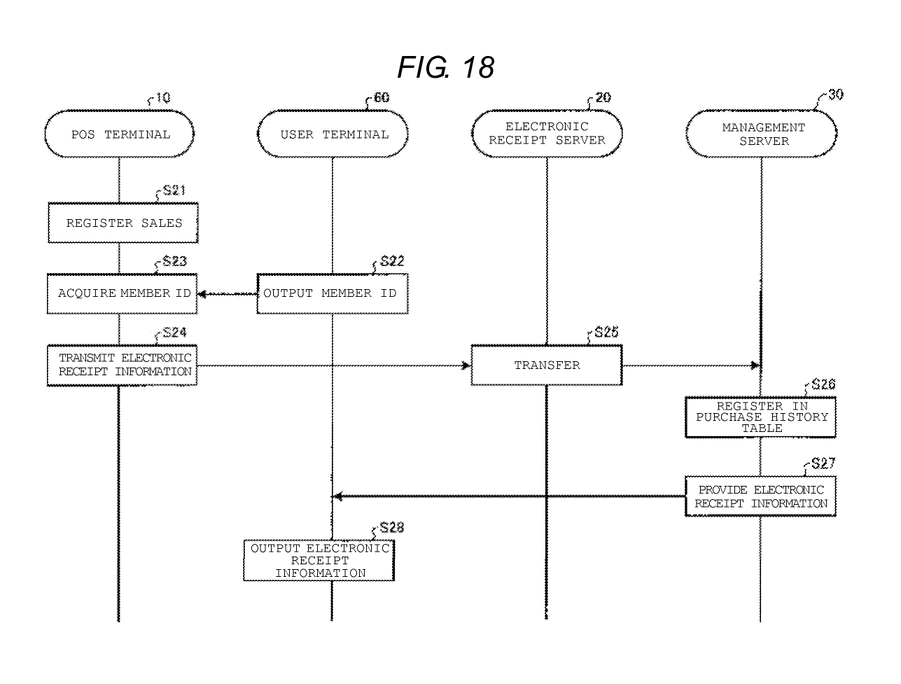

Next, operations to provide the electronic receipt in the electronic receipt system 1 will be described with reference to FIG. 18. Here, FIG. 18 is a sequence diagram showing an example of processing to provide the electronic receipt in the electronic receipt system 1. Here, it is assumed that a member ID is read by the POS terminal 10 from the user terminal 60b owned by a customer (member).

First, the sales registration section 112 of the POS terminal 10 performs sales registration of a merchandise that is purchased by the customer, based on a merchandise ID read by the code scanner 18 (Step S21). At this time, the member ID output section 613 of the user terminal 60b outputs the member ID owned by the user terminal 60b itself by communicating with the ID scanner 19 of the POS terminal 10 (Step S22). Then, the member ID acquisition section 111 of the POS terminal 10 acquires the member ID from the user terminal 60b, which is carried by the customer, via the ID scanner 19 or the like (Step S23).

Then, the electronic receipt transmission section 113 of the POS terminal 10 transmits the electronic receipt information, which includes details of the purchase transaction, along with the acquired member ID to the electronic receipt server 20 (Step S24). In the electronic receipt server 20, the electronic receipt transfer section 211 receives the electronic receipt information and the member ID and then transfers the information to the management server (Step S25). The third registration section 313 of the management server 30 receives the transferred electronic receipt information and the member ID and then registers the information in the purchase history table 372 (Step S26).

Then, the electronic receipt provision section 314 of the management server 30 provides the electronic receipt information associated with each member who is registered in the purchase history table 372, to the transmission destination address which is registered in the membership table 371 (Step S27).

In the user terminal 60, the electronic receipt receiving section 614 receives the electronic receipt information and then stores the electronic receipt information in the storage unit 67 or the like. Then, the electronic receipt output section 615 of the user terminal 60 outputs the electronic receipt information, which is received by the electronic receipt receiving section 614, to the display unit 66 or the like (Step S28).

Through the above-described process, it is possible to register details of purchase transaction at the stores SP by customers, along with the member ID, in the purchase history table 372 stored in the management server 30. In addition, it is possible to provide the electronic receipt information associated with each member who is registered in the purchase history table 372 to the transmission destination address (user terminal 60) designated in advance by the member.

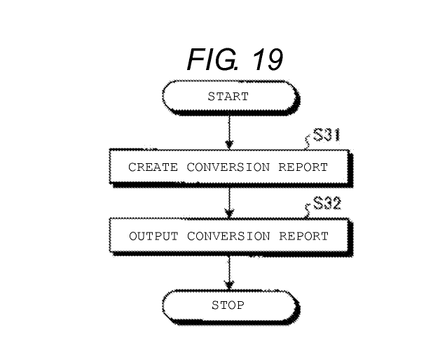

Next, operations to perform the report output in the management server 30 will be described with reference to FIG. 19. Here, FIG. 19 is a flowchart showing an example of processing to perform the report output in the management server 30.

First, the report creation section 315 of the management server 30 creates the conversion report CR, which indicates a result of the promotion program, with respect to each promotion ID based on the information stored in each table in the storage unit 37 (Step S31). Subsequently, the report output section 316 of the management server 30 outputs the conversion report CR, which is created in Step S31, to the predetermined output destination (Step S32) and completes the processing.

Through the above-described process, it is possible to output, as the conversion report CR, results of the promotion program such as the number of times the promotion information has been viewed and the number of times the target merchandise has been purchased, which are provided by the information provision server 50. As a result, it is possible to easily recognize how many target merchandises may have resulted from the promotion program, using a web page, an email, or the like.

As described above, the electronic receipt system 1 (management server 30) according to the embodiment acquires and manages the history of viewing or listening to the promotion information (promotion history) provided to the customer. In addition, the electronic receipt system 1 (management server 30) acquires and manages details of merchandises purchased by customers at each store, as the electronic receipt information. Then, the electronic receipt system 1 (management server 30) outputs the conversion report CR, which indicates a result of the promotion program, based on the acquired various information items. As a result, it is possible to effectively analyze the results (effects) of the promotion program, thereby evaluating the promotion program.

In the above embodiment, the member ID is acquired by the POS terminal 10 from the storage medium carried by the customer in the embodiment. However, exemplary embodiments are not limited thereto, and the external ID (external ID identifier) may be acquired instead. In such a case, the electronic receipt transmission section 113 of the POS terminal transmits the electronic receipt information, which includes the external ID (external ID identifier) instead of the member ID, to the management server 30 via the electronic receipt server 20. Then, the third registration section 313 of the management server 30 refers to the membership table 371, replaces the external ID, which is included in the electronic receipt information, with a corresponding member ID, and then registers the member ID in the purchase history table 372. Through this process, it is possible to perform the same processing as that in the above embodiment. In addition, a customer whose external ID cannot be replaced with a member ID is treated as a non-member.

According to the embodiment, the customer whose external ID input from the user terminal 60 does not have a corresponding member ID registered in the membership table 371 is treated as a non-member. Instead, a member ID may be newly assigned to the customer and the customer may be treated as a member. Specifically, if the management server 30 receives an external ID (external ID identifier) which does not have a corresponding member ID registered in the membership table 371, a new member ID is associated with the external ID, and the member ID is registered in the membership table 371. According to this process, all the customers who use the system may be treated substantially as members. If other information such as a name and a transmission destination address is received along with the external ID and the external ID identifier, such information may also be registered in the membership table 371.

According to the above embodiment, the promotion server 40 and the information provision server 50 are separated. However, the functions of the promotion server 40 and the information provision server 50 may be performed by a single apparatus. According to the above embodiment, the promotion information and the promotion setting information are transmitted from the promotion server 40 to the information provision server 50. However, exemplary embodiments are not limited thereto, and only the promotion information may be transmitted. In such a case, the information provision server 50 provides the promotion information to the user terminal 60 at a predetermined timing.

According to the above embodiment, the promotion information is provided via the information provision server 50. However, a method of providing the promotion information is not limited thereto. Hereinafter, other methods of providing the promotion information will be described as modification examples of the embodiment.

### First Modification Example

First, a first modification example will be described. According to the first modification example, the promotion information is provided via a signage terminal installed at a location in a station or on a street. In addition, the same reference numerals are used for the same components as those in the above embodiment, and descriptions thereof will be appropriately omitted.

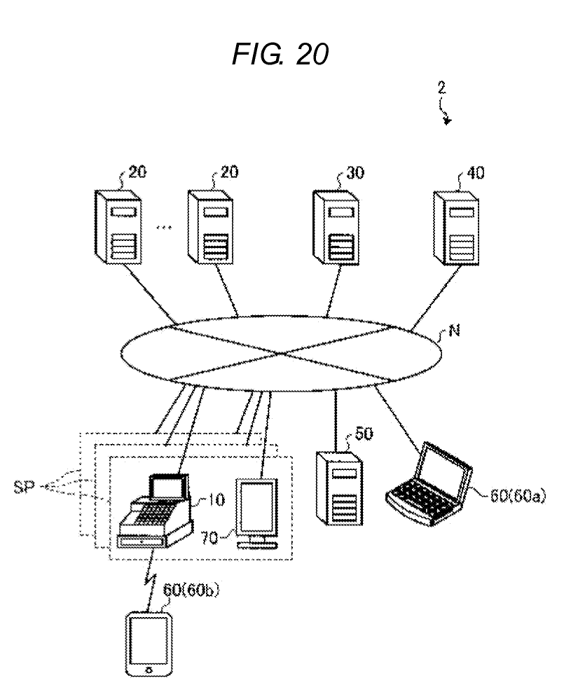

FIG. 20 illustrates an overall configuration of an electronic receipt system 2 according to the first modification example. As shown in FIG. 20, the electronic receipt system includes a signage terminal 70 in addition to the configuration of the electronic receipt system 1 illustrated in FIG. 1.

The signage terminal 70 is a display device or the like which performs digital signage display. The signage terminal 70 displays digital signage for advertising a specific store or a specific product as promotion information. In the present modification example, it is assumed that the signage terminal 70 is installed at an entrance or the like of a store SP.

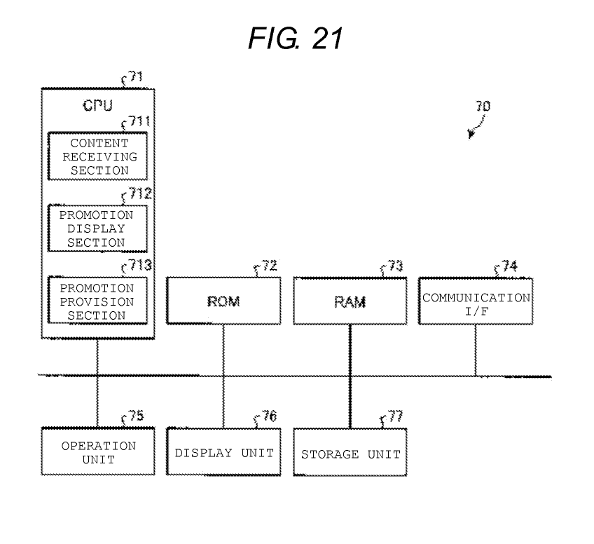

FIG. 21 is a block diagram of the signage terminal 70. As shown in FIG. 21, the signage terminal 70 includes a CPU 71, a ROM 72, a RAM 73, a communication I/F 74, an operation unit 75, a display unit 76, and a storage unit 77. In addition, the signage terminal 70 includes a time indicating device (not shown) such as an RTC.

The ROM 72 stores various programs executed by the CPU 71 and various data. The RAM 73 temporarily stores data and programs when the CPU 71 executes the various programs.

The communication I/F 74 is a communication interface connectable to the network N. The signage terminal 70 may communicate with the devices, which are connected to the network N, via the communication I/F 74. In addition, the signage terminal 70 maybe provided with a communication device capable of communicating with the user terminal 60b based on a communication scheme such as NFC. Here, it is assumed that the communication I/F 74 has a communication function capable of communicating with the user terminal 60b.

The operation unit 75 is an input device such as a keyboard or a pointing device. The operation unit 75 receives operations of the operator and outputs content of the operations to the CPU 71. The display unit 76 is a display device such as an LCD. The display unit 76 displays promotion information and the like under control of the CPU 71. In addition, the display unit 76 may be configured as a touch panel. In such a case, the touch panel functions as the operation unit 75.

The storage unit 77 is a storage device such as an HDD or an SSD. The storage unit 77 stores various programs executed by the CPU 71 and various data . In addition, the storage unit 77 stores the promotion information and the promotion setting information transmitted from the promotion server 40.

In addition, the CPU 71 generates functional units such as a content receiving section 711, a promotion display section 712, and a promotion provision section 713 by developing and executing the various programs, which are stored on the ROM 72 and the storage unit 77, in the RAM 73.

The content receiving section 711 receives the promotion information and the promotion setting information from the promotion server 40. The promotion display section 712 causes the display unit 76 to display the promotion information (content), with which the same promotion ID as that of the promotion setting information is associated, based on the promotion setting information.

The promotion provision section 713 provides the promotion information, which is displayed on the display unit 76 by the promotion display section 712, to the user terminal 60b. Here, a method of providing the promotion information is not particularly limited, and various methods may be employed. For example, the promotion information may be provided to the user terminal 60b via the communication I/F 74. If the provision method is employed, the additional information is provided along with the promotion information to the user terminal 60b. If this provision method is employed, the signage terminal 70 may transmit the promotion history information to the management server 30. Specifically, the signage terminal 70 transmits the promotion history information, which includes the member ID, to the management server 30, after acquiring the member ID or the like from the user terminal 60b when communicating with the user terminal 60b.

As another provision method, the promotion information may be provided via the information provision server 50 by displaying the code symbol, which includes information about access to the information provision server 50 and the promotion ID, along with the corresponding promotion information on the display unit 76. If this provision method is employed, the user terminal 60b accesses the information provision server 50 by reading the code symbol, which is displayed on the display unit 76, via an imaging device (not shown). At this time, the user terminal 60b notifies the information provision server 50 information of the promotion ID included in the code symbol and acquires the promotion information and the additional information corresponding to the promotion ID from the information provision server 50.

Since the processing after the promotion information is provided to the user terminal 60b is the same as that in the embodiment, the description thereof will be omitted.

According to the present modification example, it is possible to output results of the promotion program that uses the signage terminal 70 as a conversion report. As a result, it is possible to easily recognize how many target merchandises may have resulted from the promotion program that uses the signage terminal 70, thereby effectively analyzing the results (effects) of the promotion program.

According to the present modification example, the signage terminal 70 is used. However, digital signage (promotion information) may be displayed on the display unit 16 for the customer provided in the POS terminal 10. In this case, the POS terminal 10 may transmits the promotion history information to the management server 30. Specifically, when the promotion information is provided (acquired) during the merchandise sales registration, the POS terminal 10 may transmit the promotion history information, which includes the member ID read during the sales registration, to the management server 30.

### Second Modification Example

A second modification example will be described below. According to the second modification example, the promotion information is provided via a mass communication medium such as a television or a radio. The same reference numerals are used for the same components as those in the above-described embodiment, and the descriptions thereof will be appropriately omitted.

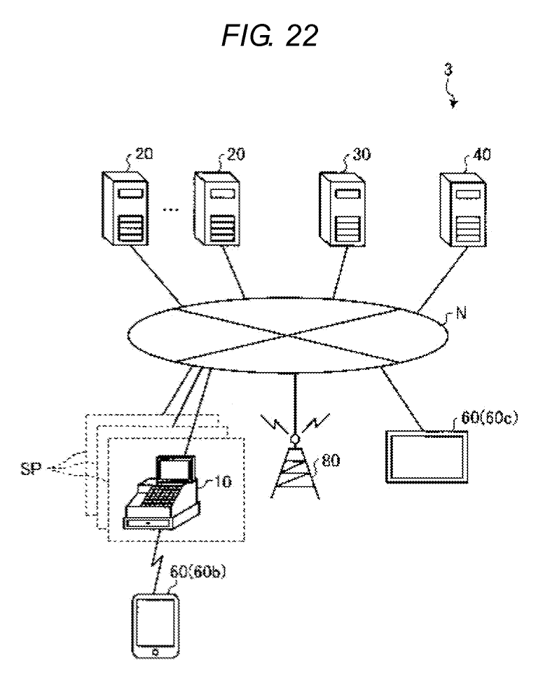

FIG. 22 illustrates an overall configuration of an electronic receipt system 3 according to the second modification example. As shown in FIG. 22, the electronic receipt system 3 includes a broadcasting device 80 instead of the information provision server 50 in the electronic receipt system 1 illustrated in FIG. 1. In addition, the electronic receipt system 3 includes a user terminal 60c, through which the user may catches airwaves, as the user terminal 60.

Here, the broadcasting device 80 is a broadcasting device (broadcasting system) which transmits airwaves for a television or a radio. The broadcasting device 80 is provided in a broadcasting station for a television or a radio, for example.

The broadcasting device 80 receives the promotion information and the promotion setting information transmitted from the promotion server 40. In addition, the broadcasting device 80 broadcasts the corresponding promotion information (a video image, sound, and the like) as a commercial message (CM) based on the promotion setting information. Here, it is assumed that the airwaves transmitted by the broadcasting device 80 include a channel number of the station of the broadcasting device 80 itself and a data and time of broadcasting. In addition, the airwaves of the CM include a corresponding promotion ID. In the present modification example, a date and time when the CM is broadcasted, for example, is defined in the promotion setting information. In the present modification example, a CM ID for identifying each CM may be used instead of the promotion ID.

The user terminal 60c is a terminal, which receives airwaves transmitted from the broadcasting device 80, and through which the user may view and listen to contents included in the airwaves, as a television program or a radio program. The user terminal 60c is located at home of the customer, for example. Here, it is assumed that the user terminal 60c is a television.

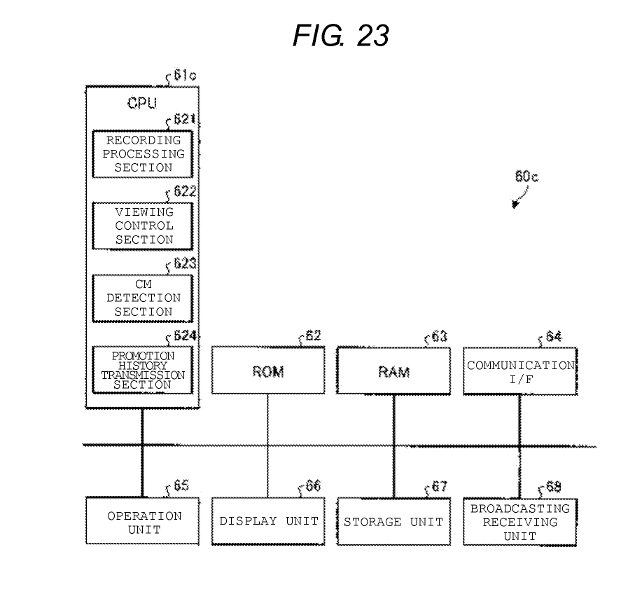

FIG. 23 is a block diagram of the user terminal 60c. As shown in FIG. 23, the user terminal 60c includes a CPU 61c, a ROM 62, a RAM 63, a communication I/F 64, an operation unit 65, a display unit 66, a storage unit 67, and a broadcasting receiving unit 68. In addition, the user terminal 60c has a time indicating device such as an RTC and a sound output device such as a speaker (not shown).

In the user terminal 60c, the operation unit 65 is an input device, such as a remote controller, which may remotely operate an operation button provided in the user terminal 60c, or the user terminal 60c itself. The storage unit 67 stores various programs executed by the CPU 61c, various data, and identifiers such as member IDs. In addition, the storage unit 67 is used as a storage region for a program, recording of which is instructed in advance, for example. The broadcasting receiving unit 68 is a tuner device that receives airwaves (programs) transmitted from a broadcasting station (broadcasting device 80) of each channel via an antenna or the like (not shown).

The CPU 61c generates functional units such as a recording processing section 621, a viewing control section 622, a CM detection section 623, and a promotion history transmission section 624 by developing and executing the various programs, which are stored on the ROM 62 and the storage unit 67, in the RAM 63.

The recording processing section 621 stores the program in the storage unit 67, upon receiving an instruction via the operation unit 65. The viewing control section 622 causes the display unit 66 to display a program being broadcasted at a channel designated by the operation unit 65 among the airwaves that may be received by the broadcasting receiving unit 68. In addition, the viewing control section 622 replays the program, which is designated by the operation unit 65, among programs recorded in the storage unit 67 and causes the display unit 66 to display the replayed program.

The CM detection section 623 detects a CM in the program being viewed. More specifically, the CM detection section 623 cooperates with the viewing control section 622 and the like, and if a promotion ID (or a CM ID) is detected in the program being viewed, then determines that the CM corresponding to the promotion ID has been viewed.

If the CM detection section 623 detects the viewing of the CM, the promotion history transmission section 624 transmits the promotion history information, which indicates the viewing of the CM, to the management server 30. Specifically, the promotion history transmission section 624 transmits the promotion history information including a channel number of the program, a date and time of the broadcasting (or a date and time of viewing), and the member ID stored on the storage unit 67, in addition to the promotion ID of the viewed CM.

In the present modification example, the information included in the promotion history information is not limited to the example. For example, information indicating whether the viewed CM (program) is received in real time by the broadcasting receiving unit 68 or is recorded in the storage unit 67 may be included in the promotion history information. In the case of the recorded program, the program may be replayed by a special replay method of fast-forwarding or skipping a period corresponding to the CM. In such a case, the CM detection section 623 may exclude the CM, which was replayed by the replay method such as fast-forwarding or skipping, from detection targets by monitoring a replay speed or the like of the viewing control section 622.

Since the processing after the promotion history information is provided to the management server 30 is the same as that in the embodiment, the description thereof will be omitted.

According to the present modification example, it is possible to output results of the promotion program (CM) viewed and listened to via a viewing device such as a television, as a conversion report. As a result, it is possible to easily recognize how many target merchandises may have resulted from the promotion program, thereby effectively analyzing the results (effects) of the promotion program.

### Third Modification Example

A third modification example will be described below. According to the third modification example, the promotion information is provided via a display medium such as a newspaper or a magazine. In addition, the same reference numerals are used for the same components as those in the above embodiment, and the descriptions thereof will be appropriately omitted.

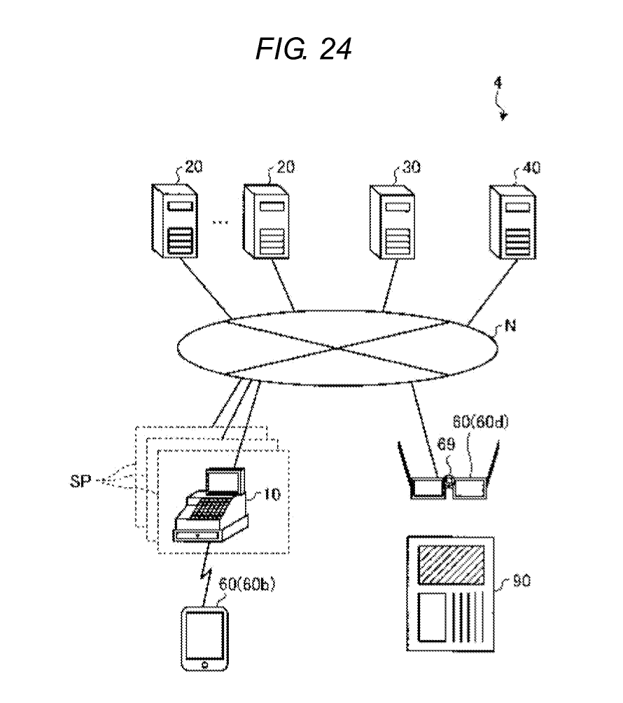

FIG. 24 illustrates an overall configuration of an electronic receipt system 4 according to the third modification example. As shown in FIG. 24, the electronic receipt system 4 includes a promotion medium 90 instead of the information provision server 50 in the electronic receipt system 1 illustrated in FIG. 1. In addition, the electronic receipt system 4 includes a user terminal 60d, which has an imaging function, as one of the user terminals 60.

The promotion medium 90 is a display medium such as a newspaper a magazine, an advertising notice, or a flyer. In the promotion medium 90, content such as characters or images provided by the promotion server 40 is displayed as promotion information. In addition, the promotion information displayed on the promotion medium 90 includes a promotion ID. In addition, the promotion medium 90 is not limited to a printed object and may be a display screen of a television, a signage terminal, or the like which displays the promotion information.

The user terminal 60d is a user terminal such as a smartphone or a wearable device provided with an imaging function. Here, it is assumed that the user terminal 60d is a glasses-type wearable device (head-mount display).

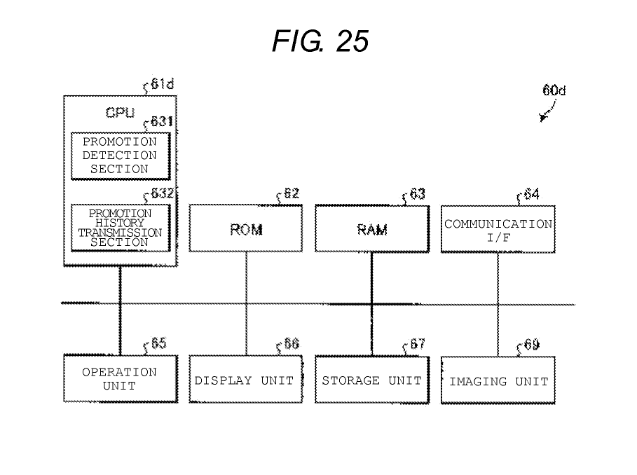

FIG. 25 is a block diagram of the user terminal 60d. As shown in FIG. 25, the user terminal 60d includes a CPU 61d, a ROM 62, a RAM 63, a communication I/F 64, an operation unit 65, a display unit 66, a storage unit 67, and an imaging unit 69. In addition, the user terminal 60d includes a time indicating device (not shown) such as an RTC.

In the user terminal 60d, the operation unit 65 is an input device such as an operation button provided in the user terminal 60d itself or a sight input controller. The display unit 66 includes a display device such as an LCD and is provided such that a display screen is displayed in a transmissive manner in front of eyes of a user who wears the user terminal 60d, for example. The imaging unit 69 is an imaging device such as a CCD or a CMOS. An imaging direction of the imaging unit 69 is determined to coincide with a sight direction of the user who wears the user terminal 60d.

The CPU 61d generates functional units such as a promotion detection section 631 and a promotion history transmission section 632 by developing and executing the various programs, which are stored on the ROM 62 or the storage unit 67, in the RAM 63.

The promotion detection section 631 detects the promotion information, which is displayed on the promotion medium 90, from the image (captured image) captured by the imaging unit 69. Here, a method of detecting the promotion information is not particularly limited, and various methods may be employed. For example, an image or a layout representing the promotion information may be detected from the captured image by using an image recognition technique, for example. Alternatively, a character string (the promotion ID, for example) representing the promotion information may be detected from the captured image using a character recognition technique. If the promotion detection section 631 detects the promotion information, the promotion detection section 631 may perform control such that a display region in the display unit 66 corresponding to the detected position is displayed in an emphasized manner.

If the promotion detection section 631 detects the promotion information, the promotion history transmission section 632 transmits the promotion history information, which indicates that the promotion information is detected, to the management server 30. Specifically, the promotion history transmission section 632 transmits the promotion history information including the promotion ID included in the promotion information detected by the promotion detection section 631, the member ID stored on the storage unit 67, and a date and time of the detection (a date and time of the promotion).

Since the processing after the promotion history information is provided to the management server 30 is the same as that in the embodiment, the description thereof will be omitted.

According to the present modification example, it is possible to output results of the promotion provided through the display medium such as a newspaper or a magazine as a conversion report as described above. As a result, it is possible to easily recognize how many target merchandises may have resulted from the promotion program using the display medium, thereby effectively analyzing the results (effects) of the promotion program.

The programs executed by the respective devices in the embodiment and the modification examples are provided in a state of being embedded in advance in recording media (the ROMs or the storage units) provided in the respective devices. However, exemplary embodiments are not limited thereto. For example, the programs may be provided as files in installable forms or executable forms in a state of being recorded in non-transitory computer-readable media such as a CD-ROM, a flexible disc (FD), a CD-R, or a Digital Versatile Disc (DVD). Furthermore, the recording media are not limited to media that are independent from the computer or the built-in system and include recording media that download and store or temporarily store programs delivered via a LAN or the Internet, for example.

The programs executed by the respective devices according to the embodiment and the modification examples may be stored on a computer connected to a network such as the Internet and may be provided by being downloaded via the network. Alternatively, the programs may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for tracking effectiveness of electronic promotions distributed to a plurality of mobile computing devices over a network, comprising:
a promotion distribution server configured to distribute content of the promotions to mobile computing devices of users, each of the promotions having a promotion ID and a product ID associated therewith, and to transmit the promotion ID and the associated product ID of each of the promotions to a central management server; and
a central management server configured to store in a first table, the promotion IDs and the products IDs in association with each other, to store in a second table, a promotion ID, a user ID, and a promotion viewing time in association with each other, upon receiving confirmation from a mobile computing device correlated to the user ID that content of a promotion having the promotion ID has been viewed using the mobile computing device at the promotion viewing time, and to store electronic receipt data that have been generated as a result of purchases of products and transmitted to the central management server, the electronic receipt data for each purchase of a product including a product ID of the product purchased, a user ID of the user who purchased the product, and a time of the purchase, wherein
the central management server is further configured to compute an effectiveness value for each of the promotions, based on the first and second tables and the electronic receipt data, the effectiveness value for a promotion being incremented for purchase of a product associated with the promotion by a user after the user has viewed content of the promotion.

2. The system according to claim 1, wherein
the promotion distribution unit includes a distribution server that distributes the content of the promotions to the mobile computing devices of users and a promotion server that transmits the promotion ID and the associated product ID of each of the promotions to the central management server.

3. The system according to claim 1, wherein
the effectiveness value of the promotion is the number of users who purchased the product associated with the promotion, after having viewed the content of the promotion.

4. The system according to claim 1, wherein
the effectiveness value of the promotion is the number of products associated with the promotion, that were purchased by users who had viewed the content of the promotion.

5. The system according to claim 1, wherein
the effectiveness value of the promotion is incremented for purchase of the product associated with the promotion by the user within a predetermined time period after the user has viewed the content of the promotion.

6. The system according to claim 1, wherein
the central management server is further configured to store in a third table, a user ID and attribute information, with respect to each user, and compute the effectiveness value with respect to each attribute based on the third table.

7. The system according to claim 6, wherein
the attribute information includes at least one of gender and an age group of the users.

8. The system according to claim 1, wherein
a store ID of a store associated a promotion is also stored in the first table, in association with a promotion ID and a product ID, and
a store ID of a store at which products were purchased is also included in the electronic receipt data.

9. The system according to claim 1, wherein
the promotion distribution unit distributes the content of the promotions through wireless communication, and
the content of each promotion includes a command that causes a mobile computing device that received the content to execute processing to transmit the confirmation to the central management server.

10. The system according to claim 1, wherein
the promotion distribution unit includes a signage terminal having a display unit,
the promotion distribution unit distributes the content of the promotions by displaying the content on the display unit of the signage terminal, and
the displayed content includes a code symbol that causes a mobile computing device to execute processing to transmit the confirmation to the central management server when an image of the code symbol is captured by the mobile computing device.

11. A method for tracking effectiveness of electronic promotions distributed to a plurality of mobile computing devices over a network, comprising:
distributing content of the promotions to mobile computing devices of users, each of the promotions having a promotion ID and a product ID associated therewith;
storing, in a first table, the promotion IDs and the products IDs in association with each other;
storing, in a second table, a promotion ID, a user ID, and a promotion viewing time in association with each other, upon receiving confirmation from a mobile computing device correlated to the user ID that content of a promotion having the promotion ID has been viewed using the mobile computing device at the promotion viewing time;
storing electronic receipt data that have been generated as a result of purchases of products, the electronic receipt data for each purchase of a product including a product ID of the product purchased, a user ID of the user who purchased the product, and a time of the purchase; and
computing an effectiveness value for each of the promotions, based on the first and second tables and the electronic receipt data, the effectiveness value for a promotion being incremented for purchase of a product associated with the promotion by a user after the user has viewed content of the promotion.

12. The method according to claim 11, wherein
the effectiveness value of the promotion is the number of users who purchased the product associated with the promotion, after having viewed the content of the promotion.

13. The method according to claim 11, wherein
the effectiveness value of the promotion is the number of products associated with the promotion, that were purchased by users who had viewed the content of the promotion.

14. The method according to claim 11, wherein
the effectiveness value of the promotion is incremented for purchase of the product associated with the promotion by the user within a predetermined time period after the user has viewed the content of the promotion.

15. The method according to claim 11, further comprising:
storing, in a third table, a user ID and attribute information, with respect to each user, wherein
the effectiveness value is computed with respect to each attribute based on the third table.

16. The method according to claim 15, wherein
the attribute information includes at least one of gender and an age group of the users.

17. The method according to claim 11, wherein
a store ID of a store associated a promotion is also stored in the first table, in association with a promotion ID and a product ID, and
a store ID of a store at which products were purchased is also included in the electronic receipt data.

18. The method according to claim 11, wherein
the content of the promotions is distributed through wireless communication, and
the content of each promotion includes a command that causes a mobile computing device that received the content to execute processing to transmit the confirmation to the central management server.

19. The method according to claim 11, wherein
the content of the promotions is distributed by displaying the content on a display unit of a signage terminal, and
the displayed content includes a code symbol that causes a mobile computing device to execute processing to transmit the confirmation to the central management server when an image of the code symbol is captured by the mobile computing device .
